(19) United States
(12) Patent Application Publication
(10) Pub. No.: US 2009/0327301 A1
(43) Pub. Date: Dec. 31, 2009

(54) Distributed Configuration Management Using Constitutional Documents

(75) Inventors: William B. Lees, Kirkland, WA (US); Rajagopalan B. Narayanan, Redmond, WA (US); Jeffrey B. Parham, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,118

(22) Filed: Jun. 26, 2008

(51) Int. Cl. G06F 17/30; G06F 17/00

(52) U.S. Cl. 707/10; 707/100; 715/237; 707/E17.122; 707/E17.01

(57) ABSTRACT

Described is a technology in a distributed configuration network management environment, in which constitutional (governing, authoritative) documents are used to perform management tasks. The constitutional documents are structured so as to be consistent, self-contained and independently validated, yet may be combined with other constitutional documents to perform a management task. A constitutional document includes a schematic language statement, data transformation statements, and rule statements. In usage, the structured document is distributed to an agent on a client machine, which processes the structured document by transforming data and applying rules, such as to enforce network policy on client machines.

### CROSS-REFERENCE TO RELATED APPLICATION

The present application is related to copending U.S. patent application [Attorney docket no. 322118.01] entitled “Distributed Configuration Management Using Loosely-Coupled Action-Style Documents” filed concurrently herewith, assigned to the assignee of the present application and hereby incorporated by reference.

### BACKGROUND

In managing a network, customers install a configuration management solution, or several solutions, sometimes from multiple vendors. Customers often use configuration documents to organize management tasks.

One problem with such documents is the number and kind of configuration documents which need to be present in the network. Even in the context of a single configuration management solution, across the entire system there may exist different kinds of configuration documents, each containing policy statements about the desired configuration. These documents are expressed in different proprietary languages, even within a single solution. This is a burden because typically each document is in a slightly different format, and thus requires different versions of tools at different segments of the network for processing.

Another problem is that after configuration management solution are deployed as systems, the systems tend to drift or diverge from their original intention/business plans. For example, once a configuration management solution is formally deployed according to some plan, the actual computers managed by the IT staff drift out of the original inventory. Further, additional configuration documents are copied in by hand, configuration documents are edited, and/or configuration documents are assigned into fixed permanent configurations.

Another problem results from the fact that configuration management solutions work by requiring that combinations of particular format documents be used in specific combinations. The correct operation of such solutions depends on certain documents being used together in certain combinations. Over time, the system becomes fragile if these subtle co-relationships are not maintained.

In sum, problems arise from the distinct formats of documents and/or the requirement that they often need to be used in special combinations. At the same time, the overall application of a specific business policy depends on an undefined combination of particular, yet different, documents.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which constitutional documents are used to authoritatively perform management tasks, in which constitutional documents are structured so as to be consistent, self-contained entities regardless of their source or their time of authoring. Although self-contained and able to be independently validated, and thus independent of any other constitutional documents, a constitutional document may be used in conjunction with one or more other constitutional documents to perform a management task.

In one aspect, a data structure such as a structured document includes at least one schematic language statement, at least one data transformation statement, and at least one rule statement. The document is structured so as to be able to be validated, without reference to an external source, as being correct with respect to executing statements of the data structure to perform a management task.

In one aspect, the structured document is distributed to an agent, which processes information corresponding to the structured document to perform a management task, including executing the document based upon a schematic statement in the document, transforming data based upon a data transformation statement in the document, and executing an if-then statement based upon a rule statement in the document.

In one aspect, an authoring mechanism specifies machine configuration policy. A transformation mechanism coupled to the authoring mechanism formalizes the configuration policy into a constitutional document for storing in a repository. A targeting and assignment mechanism identifies the constitutional document in the repository for distribution to targeted network machines, and a distribution mechanism coupled to the targeting mechanism distributes the constitutional document to the targeted network machines. Each targeted network machine includes an agent that executes the constitutional document to perform a management task on that targeted network machine.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing a distributed configuration management environment in which constitutional documents may be used to implement management tasks.

FIG. 2 is a representation of an example structure of a constitutional document.

FIG. 3 is a block diagram representing relationships between an application and example structured documents.

FIG. 4 is a block diagram representing example rollup document structures used in grouping and processing documents.

FIG. 5 is a flow diagram showing various aspects of a structured document.

FIG. 6 shows an illustrative example of a computing environment into which various aspects of the present invention may be incorporated.

### DETAILED DESCRIPTION

Various aspects of the technology described herein are generally directed towards distributed configuration management through a set of one or more data structures. In one implementation, the data structure is in the form of a structured document, referred to herein as a constitutional (or sometimes governing) document in part because of its inherent structure in governing management tasks.

In one example implementation, each constitutional document is arranged according to a format, such as one in which standard languages are nested, including a language for schematizing type information, a language for data transformation, and a language for specifying rules, constraints and/or requirements about the data. As a result, the document structure provides a consistent format in which the document is a standalone unit that can be understood without other documents and need not be used in special combinations, yet can be combined with other such documents for performing a management task.

While some of the examples described herein are directed towards an XML or XML-like document structure, it is understood that these are only example formats. Indeed, any suitable structured document and/or format may be used. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and network management in general.

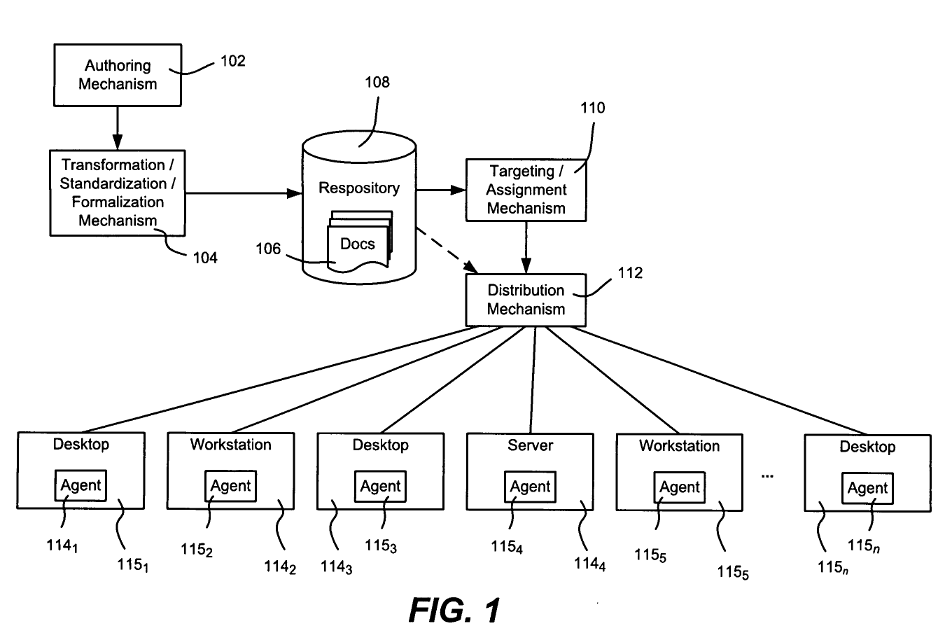

Turning to FIG. 1, there is shown an environment in which constitutional documents may be used distributed network configuration management. An authoring mechanism 102 or the like generates the content of each document, such as via a user interface and/or tools by which various desired policy and other management configuration tasks are specified. A transformation/standardization/formalization mechanism 104 processes the author-provided information into a constitutional document, which in FIG. 1 is saved along with other such documents in a set 106 maintained in a repository 108 or the like.

Some time thereafter, a targeting/assignment mechanism 110 accesses the repository 108 to locate one or more documents that are desired to perform a management task. A distribution mechanism 112 provides the documents to various machines 114₁-114ᵢ in the network, shown in FIG. 1 as desktop computers, one or more servers and/workstations. Note that there may be intermediate staging points which hold the documents to assist in distribution; although FIG. 1 shows the distribution mechanism as a single central point, this is only one example alternative, e.g., there may be more than one distribution mechanism, and/or any given distribution mechanism may employ multiple hops, or store-and-forward, between the repository and the recipients. Each such machine includes a corresponding agent 115₁-115ᵢ that interprets the document or documents to perform the specified task or tasks. As described below, this may be accomplished by standard XML processors.

Note that each of the mechanisms in FIG. 1 may operate independently of one another. Thus, a constitutional document may be authored well before it is used, even years beforehand. Similarly, a constitutional document may be reused anytime after it enters the repository 108. Moreover, not only may a constitutional document be combined with other documents, the combination may take place with a later document that is authored long after the constitutional document was authored.

Note that the delivery infrastructure is decoupled from the right of access to document content. The protection of the content of any given document is performed by rights management within the document itself. That is, the knowledge of the need of access to this content is known to the publisher and a secure constitutional authority, not in the delivery infrastructure.

Further, the decisions made at the document distribution point location are independent from the meaning of the document's structure. Decisions as to the document's location may be based on physical risk-cost assessments of the physical location of the repository.

The set of documents which a processing agency has in its possession can change over time. The names of the documents, comprising opaque containers, are given by the secure constitutional authority in advance of agency processing. The document structure contained within a particular document need not have any relation to its document container name. It is possible for any given document container name to be retracted from the document delivery infrastructure, and another document with updated structure, having a different name, being published to serve in its place. The validity of meaning of the set of documents in the agency's possession is not altered by the change of name of a particular document.

The complete set of documents that are needed and sufficient for the understanding of a given rule contract document, are published into the document repository 108. Thus, a rule contract document may be understood as the product of its time and place of publication. The standard of meaning of a given rule contract may be assured, at its original level. Future rule contract documents may be issued independently with extend levels of interpretation without breaking compatibility.

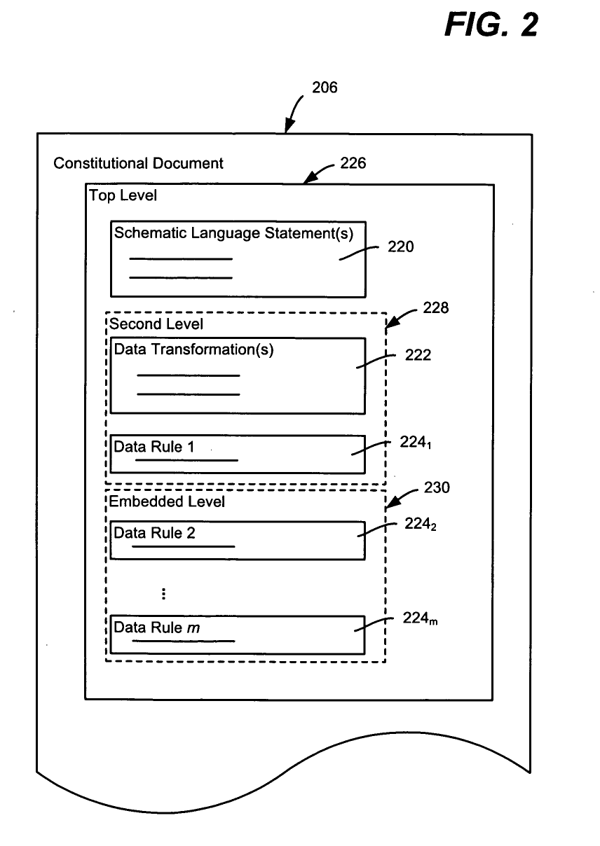

FIG. 2 shows the general structure of a constitutional document 206. As generally represented in FIG. 2, to provide such a governing document format, various (e.g., three) kinds of descriptive language syntax are used within each and every single document. This includes a “schematic” statement 220 comprising a statement of schema or type or kind of data; such statements provide templates (like ‘forms’ or ‘molds’) of which data instances may belong.

Another type is “stylistic transformative” syntax, comprising a series of data transformation declarations 222 describing one or more mathematic functions, whose processing results in the generation of some data instance. Such a data instance may be intermediate in nature, may be subject to further step-wise transformation to ultimately result in an instance conforming to a schema type, and/or may be subject to rules.

Another type of syntax is referred to as “ruling,” generally comprising a series of data rules 224₁-224ₘ such as if-then and/or if-then-else conditional rules with regard to the validity of data in the instances of the schema. Note that each kind of descriptive language syntax can be considered concrete in that statements may be interpreted directly, e.g., without requiring referencing external authorities for interpretation or disambiguation.

With respect to the statement language depth of a document, any single governing document comprises a nested series of layers of languages. A topmost or outer layer (‘top level’) 226 of language encloses the further statements within the document. Occurrences of embedded language may be present, which may appear at various points in a context of being nested within an enclosing language statement of a differing kind. Note that in one implementation, schematic language statements appear only at the top-level layer.

Ruling and stylistic language statements may appear at (either or both of) a second-level 228 or an embedded-level 230. The second-level 228 refers to language embedded as immediate child of the top-level; the embedded-level 230 refers to language embedded at further depths, beyond the second-level. The following provides an XML schema-based example of such a structured document:

```
<?xml version=“1.0” encoding=“utf-8”?>
<xs:schema targetNamespace=“urn:Content” elementFormDefault=“qualified”
xmlns:xs=“http://www.w3.org/2001/XMLSchema” xmlns:tns=“urn:Content”>
  <!---->
  <!--SML Single Model Artifact Package-->
  <!---->
  <xs:annotation xmlns:xsl=“http://www.w3.org/1999/XSL/Transform”>
    <xs:documentation />
    <xs:appinfo>
      <xsl:stylesheet version=“1.0” xmlns:msxsl=“urn:schemas-microsoft-com:xslt”
xmlns:mssmlfn=“http://schemas.microsoft.com/sml/functions/2007/03”
xmlns:smlenv=“http://schemas.microsoft.com/sml/xsl/environment/2007/03”
xmlns:smlreg=“http://schemas.microsoft.com/sml/xsl/registry/2007/03”
xmlns:smlwmi=“http://schemas.microsoft.com/sml/xsl/wmi/2007/03”
xmlns:smlscript=“http://schemas.microsoft.com/sml/xsl/script/2007/03”
xmlns:smlmsi=“http://schemas.microsoft.com/sml/xsl/msi/2007/03”
xmlns:smlfile=“http://schemas.microsoft.com/sml/xsl/file/2007/03”
xmlns:smlgac=“http://schemas.microsoft.com/sml/xsl/assembly/2007/03”
xmlns:smlmeta=“http://schemas.microsoft.com/sml/xsl/metabase/2007/03”
xmlns:smlad=“http://schemas.microsoft.com/sml/xsl/activedirectory/2007/03”
xmlns:smlsql=“http://schemas.microsoft.com/sml/xsl/sql/2007/03”
xmlns:tns_xsl_ns=“urn:Content”>
        <xsl:template name=“tns_xsl_ns:Content” match=“/”>
          <tns:Content>
            <tns:Stuff>hello</tns:Stuff>
            <tns:Other>
              <tns:Nonsense>world</tns:Nonsense>
              <tns:Stuff>xyzzy</tns:Stuff>
              <tns:Other>
                <tns:Nonsense>Traffic Lights</tns:Nonsense>
                <tns:Stuff>plugh</tns:Stuff>
              </tns:Other>
            </tns:Other>
          </tns:Content>
        </xsl:template>
      </xsl:stylesheet>
    </xs:appinfo>
  </xs:annotation>
  <xs:element name=“Content” type=“tns:ContentType”>
    <xs:annotation xmlns:xsl=“http://www.w3.org/1999/XSL/Transform”>
      <xs:documentation />
      <xs:appinfo>
        <sch:schema xmlns:sch=“http://purl.oclc.org/dsdl/schematron”
xmlns=“http://purl.oclc.org/dsdl/schematron”
xmlns:sml=“http://schemas.serviceml.org/sml/2007/02”
xmlns:mssml=“http://schemas.microsoft.com/sml/extensions/2007/03”
xmlns:smlfn=“http://schemas.serviceml.org/sml/function/2006/07”
xmlns:mssmltrans=“http://schemas.microsoft.com/sml/functions/transform/2007/03”>
          <sch:ns prefix=“tns” uri=“urn:Content” />
          <sch:pattern>
            <sch:rule context=“/tns:Content/tns:Stuff”>
              <sch:assert id=“ContentStuff” test=“. = ‘foo’” mssml:severity=“error”>
                rule one - expected to fire
            </sch:assert>
            </sch:rule>
            <sch:rule context=“/tns:Content/tns:Other”>
              <sch:report id=“ContentOther” test=“tns:Nonsense = ‘world’” mssml:severity=“error”>
                rule two - expected to fire
            </sch:report>
            </sch:rule>
            <sch:rule context=“/tns:Content/tns:Other/tns:Other/tns:Stuff”>
              <sch:assert id=“ContentOtherOtherStuff” test=“. = ‘plugh’” mssml:severity=“error”>
                rule three - not expected
            </sch:assert>
            </sch:rule>
          </sch:pattern>
        </sch:schema>
      </xs:appinfo>
    </xs:annotation>
  </xs:element>
  <xs:element name=“Other” type=“tns:OtherType” />
  <xs:element name=“Stuff” type=“tns:String” />
  <xs:element name=“Nonsense” type=“tns:String” />
  <xs:complexType name=“ContentType”>
    <xs:sequence>
      <xs:element ref=“tns:Stuff” />
      <xs:element ref=“tns:Other” />
    </xs:sequence>
  </xs:complexType>
  <xs:complexType name=“OtherType”>
    <xs:sequence>
      <xs:element ref=“tns:Nonsense” />
      <xs:element ref=“tns:Stuff” />
      <xs:element ref=“tns:Other” minOccurs=“0” maxOccurs=“unbounded” />
    </xs:sequence>
  </xs:complexType>
  <xs:simpleType name=“String”>
    <xs:restriction base=“xs:string” />
  </xs:simpleType>
</xs:schema>
```

As can be seen, the overall document is in the pattern of an XML schema, with embedded XML Schematron rules (and particularly an embedded XML XSLT Stylesheet). Thus, in this example, the set of statements corresponding to a stylesheet are followed by the declaration of the schema type, followed by the rule blob. The document thus has the conceptual entities of type, rule and action style in one structure, providing a constitutional document.

Note that the document includes xs:appinfo, which comprises the syntax for embedding one language inside another, essentially specifying the “blobs” of transforms or rules at different levels. The levels include xs:appinfo being positioned at the top-level, at a global type level, and/or at a local type level. The global type level corresponds to a document wide-scope pattern, described below, and the local type level to a type-relative scope pattern, also described below.

Also note the use of xs:import and xsl:import, which serve as master inventory as a means to establish priority/precedence. As will be understood, the set of in-use documents on a client agent form a hierarchy, or tree that is rooted at a designated head; as a tree is a tree of trees, so sub-trees of models may be pre-positioned by re-designating heads.

Note that appinfo and import are already provided by the data language suite/family (by definition), and thus give the management solution a universal means to be conflict-free, with the same decisions made the same way, regardless of where made.

As can be readily appreciated, because of its defined structure, a governing document provides the information necessary to specify some unspecified, separate, future enactment processing activity. This future activity corresponds to some computer configuration management task that will be made to occur to some computer at some time. Note that, before the activity occurs, the governing document is load-checked for correctness at a loading point; only if correct is the executing or running of the governing document allowed. The document may also be validated for correctness, with respect to itself, at the time it is formalized and put into the repository.

With respect to load-time checking, the document may refer to other documents that need to be present. The presence of these documents is part of the load checking. Further, the documents may be evaluated with respect to one another for conflicts with one another (e.g., different usage of the same name) and that any dependencies between them are proper (e.g., a document may work with data, such as a variable, defined or provided by another document, and vice-versa).

In one implementation, the interpretations of the statements are made relative to their depth of appearance. As one result, the meaning of a particular occurrence of a statement of language, at any point in a single document, does not depend on occurrences of later statements in the same document. Further, any given governing document is understood as a set of occurrences of the full set (e.g., three kinds) of language, simultaneously. The loading and correctness checking (described below) of the appearances of each kind of language may take place in parallel, essentially independent of the occurrence of other kinds of descriptive language in the same document.

The internal combination as to any given kind of descriptive language that may be combined as statements within itself is not limited by the particular combinations of other kinds of descriptive language. Any statements within each kind of language can combine in their own ways, independent of the combinations being expressed in the other kinds.

In order for correctness checking, the format of a governing document as a single physical document is described. With respect to document interpretation, a set of governing documents provides a single logical unit of load-correctness. To this end, there is a fixed meaning or standard of interpretation for a governing document, at the time it is loaded or compiled by the loading point in preparation of a processing activity. In other words, the interpretation of a set of governing documents is performed at a particular point in time on a particular computer, referred to herein as the ‘loading-time-point.’

The particular set of documents that is loaded may comprise an essentially arbitrary and unpredictable set of actual documents that, for whatever reason, happen to be present together at a particular point for loading. For example, one or more documents may have been generated by different mechanisms over time and space, which is unknown to the loading-point. The documents of a set may have been delivered to the loading-point over different modes of transport, such as file-to-file copy, email and/or web-download. The documents may have been accumulated in a staging directory or the like for an unknown period of time, prior to the occurrence of the loading time. Notwithstanding the combinatorial possibilities, the language syntax is interpreted with immediate local meaning as it happens to appear, that is, without requiring the pre-evaluation of other documents in the set.

Further, there are many possible ways to combine documents. To this end, the document structure is such that the load-time combinatorial structure of the governing document considers a set of open-ended expressions as being those which are both possible and valid. As will be understood, the document structure covers the combinatorial structure of valid possibilities within any single governing document, as well as the further combinatorial structure of valid possibilities which are possible for a set of governing documents when taken together.

As can be readily appreciated, this provides for a common understandability of some unpredicted combination of governing documents, without any requirement for prior agreement or negotiation with the loading time point. At the same time, the format is such that any sender is free to come up with new, customized and likely powerful texts, in unanticipated ways, within the scope of possible statements, while still ensuring that any irrational and/or meaningless expressions are checked for correctness.

These qualities accorded to a single document, e.g., concrete, independent, incremental, and so forth are also accorded at the level of the appearance of multiple governing documents in a set. The meaning of a particular occurrence of a governing document of language, at any point in loading a set of documents, does not depend on occurrences of later documents in the same set.

In another aspect, the language syntax allows one constitutional document to import another constitutional document. While the notion of importing may be language specific, in general, it conveys the quality of insertion at a given point. The document that is imported is inserted into the language of the document doing the importing, at the point in the text where the import statement occurs.

The language syntax also allows references between occurrences of the same kind of language in differing governing documents within a set. The reference is such that the document in which the reference appears, or the other document, may be load-checked without requiring each other to be load-checked first. The occurrence of a reference thus describes two types of governing documents, namely a referencing document and a defining document.

The syntax of the language reference may be particular to that kind of statement, however in general, within the referencing document, there is a declaration of the existence of a target entity that exists external to the current document. Within the referencing document, there are one or more appearances of uses of such a declaration, that is, a reference to the external entity. There is sufficient information between the declaration and the reference to achieve correctness checking.

Within the defining document, there is an appearance of an actual definition of the entity that is being mentioned in the other document. With regard to incremental processing, there is no requirement that the defining document be loaded first or prior to the appearance of the referencing document.

The technology described herein capitalizes on the notion of depth of embedding, to achieve application-specific behavior and meaning. For example, a document-scope pattern is present, in which statements of language appearing at the second-level apply to the activity of the entire governing document in which they appear. This establishes the concept of document-wide scope. This technique thus allows for a document to have an encompassing stylesheet or encompassing rules for the entire document.

Type-relative scope pattern is provided via statements of language appearing at an embedded-level, that is, statements occurring in a situation in which they are embedded within, or under, a particular schematic type. In this event, the embedded language only applies to occurrences of that type. This structure allows for the selective application of rules, for example.

A policy-type-relative scope Pattern allows an application to designate some of its types as ‘policy types’. This design pattern allows a context for embedded content, which applies to a grouping of other types, such other types that are members of the policy.

A member-type-relative scope pattern allows an application to designate some of its types as ‘member types’. In this design pattern, member types provide a context for nested content that applies only to instances of that particular type. Further, instances of the member type are also subject to the nested content of the member type's policy type.

Turning to aspects referred to as document set embedded meaning, different governing documents may have differing embedded content to achieve application specific behavior and meaning. One such example is a Head Body Pattern, by which an application may designate one governing document, within a total set of documents present, as the ‘head’ document. The embedded content of the head document is distinguished during processing, in that it is the first to be loaded. This allows for position-dependent roles for meaning, that is, the meaning of the content of a document loaded as the head document makes it act in a primary role; the meaning of content of a document being loaded after the head makes it act in a secondary or dependent role.

Within a set of governing documents, an application may organize or assign the meaning of the documents, such as in relation to how frequently they will be delivered or appear at a computer. An application may choose to have a set of long-lived, relatively unchanging governing documents, which are designated the ‘base’ documents. The application may choose to have these base documents be mandatory, in that occurrences of these base documents needs to be present at all times. These base documents thus act as a library of standard content, which are made available to the other documents, and thus need to be available at the load-time-point. In contrast, member documents are those that may or may not appear with respect to the base documents or other member documents.

The document structure represented by a document container name may be added and replaced at an individual document level, without affecting the interpretation of other document structures that are already published. As described herein, documents are related together for processing by virtue of their internal structure, without regard to their document container names, or the publication order of their individual member document structures.

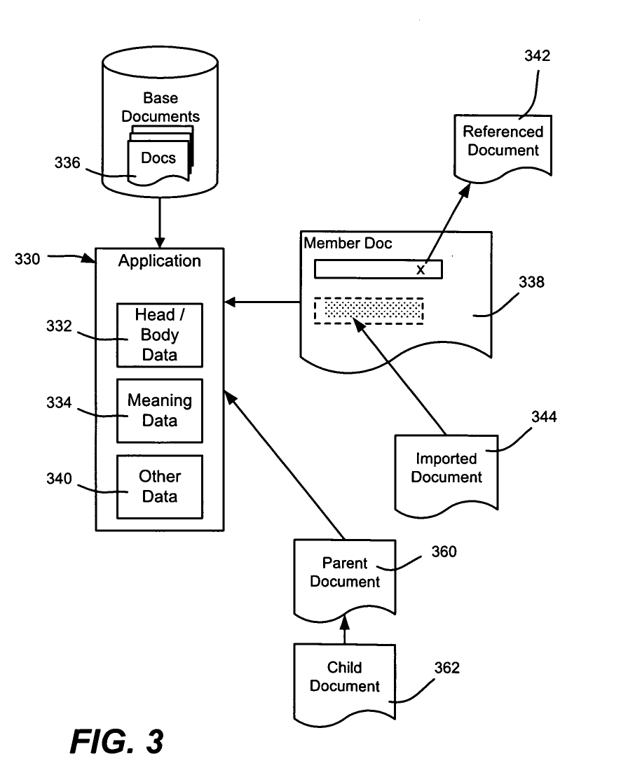

FIG. 3 summarizes various example aspects of an application 330 and various document concepts. In FIG. 3, the example application 330 includes (or otherwise references) head body data 332 that specifies document load ordering as described above, and meaning data 334 that specifies which document or documents are base documents 336 and which is a member document 338 (note that multiple member documents may be specified). The application may include other data 336.

As represented in the example of FIG. 3, the member document 338 includes a reference to a referenced document 342, and thus the member document 338 is also a defining document. The member document 338 also imports content from an imported document 344.

Still further shown in FIG. 3 is the concept of a parent-child relationship, shown via a parent document 360 and child document 362. A child document is one that references a parent document; a parent may thus have multiple child documents. A child document also may be a parent to another child, and so on. When two items are in a parent-child situation, the parent is evaluated before the child; e.g., a model stylesheet, which is a child, declares another model stylesheet to be its parent, (that is unless the model declares that it has a base, then this stylesheet is not a child, whereas when a model declares that it has a base and names another model as its base or parent is the child, and the named model is the parent).

In general, a parent document is extended by a child document, e.g., an administrator authors a parent document, and then later wants to extend that document with some content, and may do so by authoring a child document that specifies its relationship with the parent document.

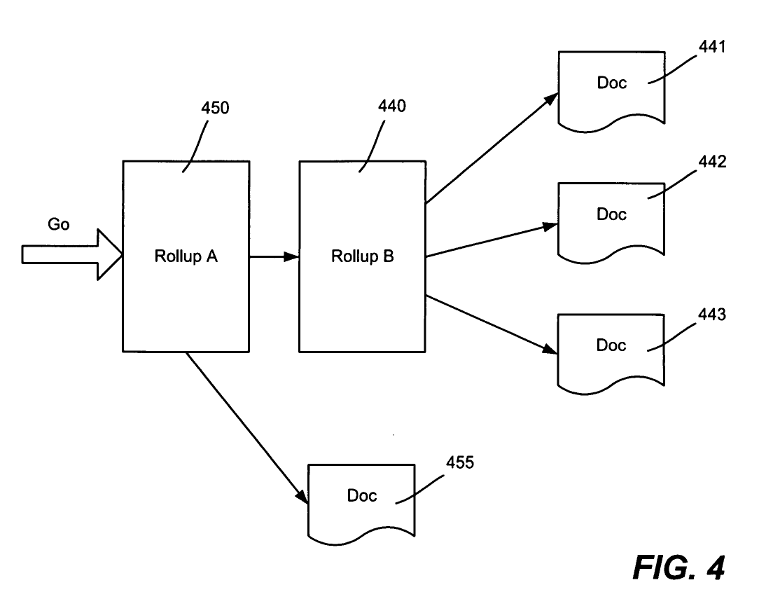

Turning to another aspect, a rollup document (also called a baseline document in the technology) is one which an administrator authors so as to treat two or more other documents as a unit. By way of example, FIG. 4 shows a rollup B 440 that specifies the processing of three (singleton) documents 441-443. A rollup may describe the order of execution, as well as the success/failure conditions for any or all of these documents. For example, the rollup 440 may specify that the documents are to be processed in the order of documents 441-443, or a certain one first and then the other two in any order, and so on. Further, the rollup may specify that document processing has to succeed for each document, or else all fail together. Alternatively, some subset may be treated together, e.g., documents 441 and 442 succeed or fail together, but document 443 can succeed or fail on its own.

A rollup thus gives an administrator control over ordering and/or success/failure considerations. As also shown in FIG. 4, a rollup itself may be controlled by a rollup, e.g., the rollup A 450 controls the processing (e.g., order and success/failure) of the rollup B 440 along with the document 455. Note that rollups may reference one or more other rollup documents, and/or singleton documents, and (in one implementation) only reference them, and do not contain the actual content of those documents.

Note that a constitutional document may contain an additional section, which may be referred to as the ‘source section’. More particularly, when the constitutional document is the product of a generator, the constitutional document contains the original input document to the transformational process which generated this constitutional document, as in the example below:

```
<?xml version=“1.0” encoding=“utf-8”?>
<xs:schema elementFormDefault=“qualified”
targetNamespace=“http://schemas.microsoft.com/systemsmanagementserver/SCCMSITE_F3841056-
33E5-46D8-B921-6E26ABFACC4B/OS_C765723E-B286-4A65-CB6C-6218EBAFC386/1”
xmlns:xs=“http://www.w3.org/2001/XMLSchema” xmlns:xsl=“http://www.w3.org/1999/XSL/Transform”
xmlns:sch=“http://purl.oclc.org/dsdl/schematron” xmlns:sdm=“http://schemas.microsoft.com/sdm/2005/09”
xmlns:sml=“http://schemas.serviceml.org/sml/2007/02”
xmlns:mssml=“http://schemas.microsoft.com/sml/extensions/2007/03”
xmlns:smlfn=“http://schemas.serviceml.org/sml/function/2006/07”
xmlns:mssmltrans=“http://schemas.microsoft.com/sml/functions/transform/2007/03”
xmlns:mgt=“http://schemas.microsoft.com/systemsmanagementserver/ManagedEntity_1.0.0.0”
xmlns:sfw=“http://schemas.microsoft.com/systemsmanagementserver/Software_1.0.0.0”
xmlns:cis=“http://schemas.microsoft.com/systemsmanagementserver/ConfigurationItems_1.0.0.0”
xmlns:fs=“http://schemas.microsoft.com/systemsmanagementserver/FileSystem_1.0.0.0”
xmlns:reg=“http://schemas.microsoft.com/systemsmanagementserver/Registry_1.0.0.0”
xmlns:dci=“http://schemas.microsoft.com/SystemsCenterConfigurationManager/DesiredConfiguration/InstanceData/2006/04”
xmlns:dcm=“http://schemas.microsoft.com/SystemsCenterConfigurationManager/2006/03/24/DesiredConfiguration”
xmlns:tns=“http://schemas.microsoft.com/systemsmanagementserver/SCCMSITE_F3841056-
33E5-46D8-B921-6E26ABFACC4B/OS_C765723E-B286-4A65-CB6C-6218EBAFC386/1”
xmlns:ns_OS_C765723E-B286-4A65-CB6C-
6218EBAFC386_this=“http://schemas.microsoft.com/systemsmanagementserver/SCCMSITE_F3841056-
33E5-46D8-B921-6E26ABFACC4B/OS_C765723E-B286-4A65-CB6C-6218EBAFC386/1”
xmlns:ns_eng=“http://schemas.microsoft.com/sml/protocols/transform/2007/03”>
  <xs:import namespace=“http://purl.oclc.org/dsdl/schematron” />
  <xs:import namespace=“http://schemas.serviceml.org/sml/2007/02” />
  <xs:import namespace=“http://schemas.microsoft.com/sml/extensions/2007/03” />
  <xs:import namespace=“http://schemas.microsoft.com/sdm/2005/09” />
  <xs:import
namespace=“http://schemas.microsoft.com/SystemsCenterConfigurationManager/2006/03/24/DesiredConfiguration” />
  <xs:import namespace=“http://schemas.microsoft.com/systemsmanagementserver/Software_1.0.0.0” />
  <xs:import
namespace=“http://schemas.microsoft.com/systemsmanagementserver/ManagedEntity_1.0.0.0” />
  <xs:import
namespace=“http://schemas.microsoft.com/systemsmanagementserver/ConfigurationItems_1.0.0.0” />
  <xs:import namespace=“http://schemas.microsoft.com/systemsmanagementserver/Registry_1.0.0.0” />
  <xs:import namespace=“http://schemas.microsoft.com/systemsmanagementserver/FileSystem_1.0.0.0” />
  <xs:import
namespace=“http://schemas.microsoft.com/SystemsCenterConfigurationManager/DesiredConfiguration/InstanceData/2006/04” />
  <xs:import namespace=“http://schemas.microsoft.com/sml/protocols/transform/2007/03” />
  <xs:annotation>
    <xs:documentation />
    <xs:appinfo>
      <DesiredConfigurationDigest
xmlns=“http://schemas.microsoft.com/SystemsCenterConfigurationManager/2006/03/24/DesiredConfiguration”>
        <OperatingSystem AuthoringScopeId=“SCCMSITE_F3841056-33E5-46D8-B921-6E26ABFACC4B”
LogicalName=“OS_C765723E-B286-4A65-CB6C-6218EBAFC386” Version=“1”>
          <Annotation>
            <DisplayName Text=“Win2K3Sp1” />
            <Description Text=“Windows 2003 Server -Enterprise Edition SP1” />
          </Annotation>
          <Parts>
            <ParentReferences />
          </Parts>
          <Settings>
            <RootComplexSetting />
          </Settings>
            <OperatingSystem DiscoveryInfo BuildVersion=“3790” MajorVersion=“5” MinorVersion=“2”
ServicePackMajorVersion=“050324” ServicePackMinorVersion=“1447” />
        <OperatingSystem>
      <DesiredConfigurationDigest>
      <xsl:stylesheet version=“1.0” xmlns:exsl=“http://exslt.org/common”
xmlns:xsi=“http://www.w3.org/2001/XMLSchema-instance” xmlns:msxsl=“urn:schemas-microsoft-com:xslt”
xmlns:mssmlfn=“http://schemas.microsoft.com/sml/functions/2007/03”
xmlns:factory=“http://schemas.microsoft.com/sml/factories/transform/2007/03”
xmlns:engine=“http://schemas.microsoft.com/sml/protocols/transform/2007/03”
xmlns:smlenv=“http://schemas.microsoft.com/sml/xsl/environment/2007/03”
xmlns:smlreg=“http://schemas.microsoft.com/sml/xsl/registry/2007/03”
xmlns:smlwmi=“http://schemas.microsoft.com/sml/xsl/wmi/2007/03”
xmlns:smlscript=“http://schemas.microsoft.com/sml/xsl/script/2007/03”
xmlns:smlmsi=“http://schemas.microsoft.com/sml/xsl/msi/2007/03”
xmlns:smlfile=“http://schemas.microsoft.com/sml/xsl/file/2007/03”
xmlns:smlgac=“http://schemas.microsoft.com/sml/xsl/assembly/2007/03”
xmlns:smlmeta=“http://schemas.microsoft.com/sml/xsl/metabase/2007/03”
xmlns:smlad=“http://schemas.microsoft.com/sml/xsl/activedirectory/2007/03”
xmlns:smlsql=“http://schemas.microsoft.com/sml/xsl/sql/2007/03”
xmlns:upd=“http://schemas.microsoft.com/SystemsCenterConfigurationManager/xsl/Updates/2006/04”>
        <xsl:import href=“DcmDiscovery.xsd” />
        <xsl:variable name=“SCCMSITE_F3841056-33E5-46D8-B921-6E26ABFACC4B_OS_C765723E-
B286-4A65-CB6C-6218EBAFC386_1_MinFunctionalVersion” select=“2” />
        <xsl:variable name=“SCCMSITE_F3841056-33E5-46D8-B921-6E26ABFACC4B_OS_C765723E-
B286-4A65-CB6C-6218EBAFC386_1_AuthoredFunctionalVersion” select=“2” />
        <xsl:template match=“/”>
          <xsl:call-template name=“Discover_OSCI_Policy_SCCMSITE_F3841056-33E5-46D8-B921-
6E26ABFACC4B_OS_C765723E-B286-4A65-CB6C-6218EBAFC386_1” />
        </xsl:template>
        <xsl:template name=“Discover_OSCI_Policy_SCCMSITE_F3841056-33E5-46D8-B921-
6E26ABFACC4B_OS_C765723E-B286-4A65-CB6C-6218EBAFC386_1”>
          <exsl:document href=“/SCCMSITE_F3841056-33E5-46D8-B921-6E26ABFACC4B_OS_C765723E-
B286-4A65-CB6C-6218EBAFC386_1/DcmCiOsPolicy.xml”>
            <xsl:call-template name=“Discover_OSCI_Policy_InstanceDoc_SCCMSITE_F3841056-33E5-46D8-
B921-6E26ABFACC4B_OS_C765723E-B286-4A65-CB6C-6218EBAFC386_1”>
              <xsl:with-param name=“InstanceDocBase” select=“‘/SCCMSITE_F3841056-33E5-46D8-B921-
6E26ABFACC4B_OS_C765723E-B286-4A65-CB6C-6218EBAFC386_1’” />
            </xsl:call-template>
          </exsl:document>
          <ProductId
xmlns=“http://schemas.microsoft.com/systemsmanagementserver/Software_1.0.0.0”>/SCCMSITE_F3841056-
33E5-46D8-B921-6E26ABFACC4B_OS_C765723E-B286-4A65-CB6C-
6218EBAFC386_1/DcmCiOsPolicy.xml</ProductId>
        </xsl:template>
        <xsl:template name=“Discover_OSCI_Policy_InstanceDoc_SCCMSITE_F3841056-33E5-46D8-B921-
6E26ABFACC4B_OS_C765723E-B286-4A65-CB6C-6218EBAFC386_1”>
          <xsl:param name=“InstanceDocBase” />
          <xsl:variable name=“ApplicabilityRaw”>
            <xsl:call-template name=“Discover_OSCI_Policy_Applicability_SCCMSITE_F3841056-33E5-46D8-
B921-6E26ABFACC4B_OS_C765723E-B286-4A65-CB6C-6218EBAFC386_1” />
          </xsl:variable>
          <xsl:variable name=“Applicability” select=“boolean(number(normalize-space($ApplicabilityRaw)))” />
          <xsl:variable name=“MinVersion” select=“$SCCMSITE_F3841056-33E5-46D8-B921-
6E26ABFACC4B_OS_C765723E-B286-4A65-CB6C-6218EBAFC386_1_MinFunctionalVersion” />
          <xsl:variable name=“AuthoredVersion” select=“$SCCMSITE_F3841056-33E5-46D8-B921-
6E26ABFACC4B_OS_C765723E-B286-4A65-CB6C-6218EBAFC386_1_AuthoredFunctionalVersion” />
          <xsl:variable name=“Negotiation”>
            <xsl:variable name=“Action”>
              <engine:NegotiateFunctionalVersion>
                <engine:ModelMinVersion>
                  <xsl:value-of select=“$MinVersion” />
                </engine:ModelMinVersion>
              </engine:NegotiateFunctionalVersion>
            </xsl:variable>
            <xsl:apply-templates select=“msxsl:node-set($Action)/*[1]” mode=“engine:DiscoveryEngine” />
          </xsl:variable>
          <xsl:variable name=“FunctionalVersionNode” select=“msxsl:node-set($Negotiation)/*[1]” />
          <xsl:variable name=“DiscoveryMinVersion”
select=“number(concat(‘0’,$FunctionalVersionNode/engine:DiscoveryMinVersion/text( )))” />
          <xsl:variable name=“VersionCompatible” select=“boolean($DiscoveryMinVersion)” />
          <xsl:message>
                    OS CI SCCMSITE_F3841056-33E5-46D8-B921-6E26ABFACC4B_OS_C765723E-B286-4A65-
CB6C-6218EBAFC386_1 Version Compatibility Data:
                    Min Functional Version: <xsl:value-of select=“$MinVersion” />
                    Authored Functional Version: <xsl:value-of select=“$AuthoredVersion” />
                    Discovery Min Functional Version:
<xsl:value-of select=“$DiscoveryMinVersion”/></xsl:message>
          <xsl:variable name=“QueryResult”>
            <QueryResultFragment>
              <xsl:choose>
                <xsl:when test=“$VersionCompatible = ‘true’ and $Applicability = ‘true’”>
                  <xsl:call-template name=“Discover_OSCI_Policy_TypeEnum_SCCMSITE_F3841056-33E5-
46D8-B921-6E26ABFACC4B_OS_C765723E-B286-4A65-CB6C-6218EBAFC386_1” />
                </xsl:when>
                <xsl:otherwise>
                  <xsl:variable name=“SetErrorCondition1” select=“smlwmi:setLastError(false( ))” />
                </xsl:otherwise>
              </xsl:choose>
            </QueryResultFragment>
          </xsl:variable>
          <xsl:variable name=“QueryResultSet” select=“msxsl:node-
set($QueryResult)/QueryResultFragment/QueryDataFragment/smlwmi:Object” />
          <xsl:variable name=“ResultsPresent” select=“boolean($QueryResultSet)” />
          <xsl:variable name=“ErrorCondition” select=“smlwmi:getLastError( )” />
          <xsl:variable name=“IsComplete” select=“$ResultsPresent or not($ErrorCondition)” />
          <xsl:message>
                    OS CI SCCMSITE_F3841056-33E5-46D8-B921-6E26ABFACC4B_OS_C765723E-B286-4A65-
CB6C-6218EBAFC386_1 Instance Completeness Data:
                    Applicability: <xsl:value-of select=“$Applicability” />
                    Version Compatible: <xsl:value-of select=“$VersionCompatible” />
                    Results Present: <xsl:value-of select=“$ResultsPresent” />
                    WMI Error: <xsl:value-of select=“$ErrorCondition” /></xsl:message>
          <xsl:message>
                    OS CI SCCMSITE_F3841056-33E5-46D8-B921-6E26ABFACC4B_OS_C765723E-B286-4A65-
CB6C-6218EBAFC386_1 Policy Discovery
                    Applicability: <xsl:value-of select=“$Applicability” />
                    Set Completeness: <xsl:value-of select=“$IsComplete” />
                    Version Compatible: <xsl:value-of select=“$VersionCompatible” />
                    CI Instance Count: <xsl:value-of select=“count($QueryResultSet)” /></xsl:message>
          <SCCMSITE_F3841056-33E5-46D8-B921-6E26ABFACC4B_OS_C765723E-B286-4A65-CB6C-
6218EBAFC386_1
xmlns=“http://schemas.microsoft.com/systemsmanagementserver/SCCMSITE_F3841056-33E5-46D8-
B921-6E26ABFACC4B/OS_C765723E-B286-4A65-CB6C-6218EBAFC386/1”>
            <cis:Applicability>
              <xsl:value-of select=“$Applicability” />
            </cis:Applicability>
            <cis:SetCompleteness>
              <xsl:value-of select=“$IsComplete” />
            </cis:SetCompleteness>
            <cis:ConfigurationExtensions>
              <cis:OtherExtensionElement>
                <dci:VersionInfo>
                  <dci:VersionCompatible>
                    <xsl:value-of select=“$VersionCompatible” />
                  </dci:VersionCompatible>
                  <dci:AuthoredFunctionalVersion>
                    <xsl:value-of select=“$AuthoredVersion” />
                  </dci:AuthoredFunctionalVersion>
                  <dci:MinFunctionalVersion>
                    <xsl:value-of select=“$MinVersion” />
                  </dci:MinFunctionalVersion>
                  <dci:EngineFunctionalVersion>
                    <xsl:value-of select=“$DiscoveryMinVersion” />
                  </dci:EngineFunctionalVersion>
                </dci:VersionInfo>
              </cis:OtherExtensionElement>
            </cis:ConfigurationExtensions>
            <xsl:for-each select=“$QueryResultSet”>
              <SCCMSITE_F3841056-33E5-46D8-B921-6E26ABFACC4B_OS_C765723E-B286-4A65-CB6C-
6218EBAFC386_1_Ref>
                <xsl:attribute name=“uri”>
                  <xsl:value-of
select=“concat($InstanceDocBase,‘/Instance_’,string(position( )),‘/DcmCiOsType.xml’)” />
                </xsl:attribute>
              </SCCMSITE_F3841056-33E5-46D8-B921-6E26ABFACC4B_OS_C765723E-B286-4A65-CB6C-
6218EBAFC386_1_Ref>
            </xsl:for-each>
          </SCCMSITE_F3841056-33E5-46D8-B921-6E26ABFACC4B_OS_C765723E-B286-4A65-CB6C-
6218EBAFC386_1>
          <xsl:for-each select=“$QueryResultSet”>
            <xsl:call-template name=“Discover_OSType_SCCMSITE_F3841056-33E5-46D8-B921-
6E26ABFACC4B_OS_C765723E-B286-4A65-CB6C-6218EBAFC386_1”>
              <xsl:with-param name=“DocPath”
select=“concat($InstanceDocBase,‘/Instance_’,string(position( )),‘/DcmCiOsType.xml’)” />
            </xsl:call-template>
          </xsl:for-each>
        </xsl:template>
        <xsl:template name=“Discover_OSCI_Policy_Applicability_SCCMSITE_F3841056-33E5-46D8-B921-
6E26ABFACC4B_OS_C765723E-B286-4A65-CB6C-6218EBAFC386_1”>
          <xsl:value-of select=“1” />
        </xsl:template>
        <xsl:template xml:space=“default” name=“Discover_OSCI_Policy_TypeEnum_SCCMSITE_F3841056-
33E5-46D8-B921-6E26ABFACC4B_OS_C765723E-B286-4A65-CB6C-6218EBAFC386_1”>
          <xsl:call-template name=“Discover_OSCI_Policy_TypeEnumHelper_SCCMSITE_F3841056-33E5-
46D8-B921-6E26ABFACC4B_OS_C765723E-B286-4A65-CB6C-6218EBAFC386_1” />
        </xsl:template>
        <xsl:template xml:space=“default”
name=“Discover_OSCI_Policy_TypeEnumHelper_SCCMSITE_F3841056-33E5-46D8-B921-
6E26ABFACC4B_OS_C765723E-B286-4A65-CB6C-6218EBAFC386_1”>
          <xsl:variable name=“VersionLiteral”>‘5.2.3790’</xsl:variable>
          <xsl:variable name=“ServicePackMajorVersion”>050324</xsl:variable>
          <xsl:variable name=“ServicePackMinorVersion”>1447</xsl:variable>
          <xsl:variable name=“QueryResult” select=“smlwmi:query( concat(‘select * from
Win32_OperatingSystem where Version=’, $VersionLiteral, ‘ and ServicePackMajorVersion=’,
number($ServicePackMajorVersion), ‘ and ServicePackMinorVersion=’,
number($ServicePackMinorVersion) ))” />
          <QueryDataFragment>
            <xsl:copy-of select=“$QueryResult” />
          </QueryDataFragment>
        </xsl:template>
        <xsl:template name=“Discover_OSType_SCCMSITE_F3841056-33E5-46D8-B921-
6E26ABFACC4B_OS_C765723E-B286-4A65-CB6C-6218EBAFC386_1”>
          <xsl:param name=“DocPath” />
          <xsl:message>
                    OSCI SCCMSITE_F3841056-33E5-46D8-B921-6E26ABFACC4B_OS_C765723E-B286-4A65-
CB6C-6218EBAFC386_1 discovered instance: <xsl:value-of select=“smlwmi:Property[@Name=‘Name’]”/>
</xsl:message>
          <exsl:document href=“{$DocPath}”>
            <SCCMSITE_F3841056-33E5-46D8-B921-6E26ABFACC4B_OS_C765723E-B286-4A65-CB6C-
6218EBAFC386_1_Instance
xmlns=“http://schemas.microsoft.com/systemsmanagementserver/SCCMSITE_F3841056-33E5-46D8-
B921-6E26ABFACC4B/OS_C765723E-B286-4A65-CB6C-6218EBAFC386/1”>
              <sfw:WindowsOperatingSystem>
                <mgt:Name>
                  <xsl:value-of select=“smlwmi:Property[@Name=‘Name’]” />
                </mgt:Name>
                <mgt:Caption>
                  <xsl:value-of select=“smlwmi:Property[@Name=‘Caption’]” />
                </mgt:Caption>
                <mgt:Description>
                  <xsl:value-of select=“smlwmi:Property[@Name=‘Description’]” />
                </mgt:Description>
                <sfw:Manufacturer>
                  <xsl:value-of select=“smlwmi:Property[@Name=‘Manufacturer’]” />
                </sfw:Manufacturer>
                <sfw:Version>
                  <xsl:value-of select=“smlwmi:Property[@Name=‘Version’]” />
                </sfw:Version>
                <sfw:SKU>
                  <xsl:value-of select=“smlwmi:Property[@Name=‘ProductType’]” />
                </sfw:SKU>
                <sfw:TargetArchitecture>
                  <xsl:value-of select=“smlwmi:Property[@Name=‘OSType’]” />
                </sfw:TargetArchitecture>
                <sfw:ProductId>
                  <xsl:value-of select=“smlwmi:Property[@Name=‘Name’]” />
                </sfw:ProductId>
                <sfw:BuildNumber>
                  <xsl:value-of select=“smlwmi:Property[@Name=‘BuildNumber’]” />
                </sfw:BuildNumber>
                <sfw:ServicePackMajorVersion>
                  <xsl:value-of select=“smlwmi:Property[@Name=‘ServicePackMajorVersion’]” />
                </sfw:ServicePackMajorVersion>
                <sfw:ServicePackMinorVersion>
                  <xsl:value-of select=“smlwmi:Property[@Name=‘ServicePackMinorVersion’]” />
                </sfw:ServicePackMinorVersion>
                <sfw:Language>
                  <xsl:value-of select=“smlwmi:Property[@Name=‘OSLanguage’]” />
                </sfw:Language>
              </sfw:WindowsOperatingSystem>
              <xsl:variable name=“InstallationTime” select=“smlwmi:Property[@Name=‘InstallDate’]” />
              <xsl:if test=“boolean($InstallationTime)”>
                <sfw:InstallationTime>
                  <xsl:value-of select=“$InstallationTime” />
                </sfw:InstallationTime>
              </xsl:if>
              <sfw:InstallationContext />
              <xsl:call-template name=“Discover_OSType_Extension_SCCMSITE_F3841056-33E5-46D8-B921-
6E26ABFACC4B_OS_C765723E-B286-4A65-CB6C-6218EBAFC386_1” />
            </SCCMSITE_F3841056-33E5-46D8-B921-6E26ABFACC4B_OS_C765723E-B286-4A65-CB6C-
6218EBAFC386_1_Instance>
          </exsl:document>
        </xsl:template>
        <xsl:template name=“Discover_OSType_Extension_SCCMSITE_F3841056-33E5-46D8-B921-
6E26ABFACC4B_OS_C765723E-B286-4A65-CB6C-6218EBAFC386_1”>
          <xsl:message>
                  OSCI SCCMSITE_F3841056-33E5-46D8-B921-6E26ABFACC4B_OS_C765723E-B286-4A65-
CB6C-6218EBAFC386_1 ArchMode is always set to 32-bit application context
                  OSCI SCCMSITE_F3841056-33E5-46D8-B921-6E26ABFACC4B_OS_C765723E-B286-4A65-
CB6C-6218EBAFC386_1 UserSid is always set to empty
                  </xsl:message>
          <xsl:variable name=“ArchMode” select=“32” />
          <xsl:variable name=“UserSid” select=“‘’” />
          <xsl:call-template name=“Discover_RootPart_SCCMSITE_F3841056-33E5-46D8-B921-
6E26ABFACC4B_OS_C765723E-B286-4A65-CB6C-6218EBAFC386_1”>
            <xsl:with-param name=“ArchMode” select=“$ArchMode” />
            <xsl:with-param name=“UserSid” select=“$UserSid” />
          </xsl:call-template>
          <xsl:call-template name=“Discover_RootSetting_SCCMSITE_F3841056-33E5-46D8-B921-
6E26ABFACC4B_OS_C765723E-B286-4A65-CB6C-6218EBAFC386_1”>
            <xsl:with-param name=“ArchMode” select=“$ArchMode” />
            <xsl:with-param name=“UserSid” select=“$UserSid” />
          </xsl:call-template>
        </xsl:template>
        <xsl:template name=“Discover_RootPart_SCCMSITE_F3841056-33E5-46D8-B921-
6E26ABFACC4B_OS_C765723E-B286-4A65-CB6C-6218EBAFC386_1”>
          <xsl:param name=“ArchMode” />
          <xsl:param name=“UserSid” />
          <xsl:variable name=“EngineActions”>
            <engine:TransactionSequence Name=“Discover_RootPart_SCCMSITE_F3841056-33E5-46D8-
B921-6E26ABFACC4B_OS_C765723E-B286-4A65-CB6C-6218EBAFC386_1” />
          </xsl:variable>
          <xsl:apply-templates select=“msxsl:node-set($EngineActions)” mode=“engine:DiscoveryEngine” />
        </xsl:template>
        <xsl:template name=“Discover_RootSetting_SCCMSITE_F3841056-33E5-46D8-B921-
6E26ABFACC4B_OS_C765723E-B286-4A65-CB6C-6218EBAFC386_1”>
          <xsl:param name=“ArchMode” />
          <xsl:param name=“UserSid” />
          <xsl:variable name=“EngineActions”>
            <engine:TransactionSequence Name=“Discover_RootSetting_SCCMSITE_F3841056-33E5-46D8-
B921-6E26ABFACC4B_OS_C765723E-B286-4A65-CB6C-6218EBAFC386_1” />
          </xsl:variable>
          <xsl:apply-templates select=“msxsl:node-set($EngineActions)” mode=“engine:DiscoveryEngine” />
        </xsl:template>
      </xsl:stylesheet>
    </xs:appinfo>
  </xs:annotation>
  <xs:complexType name=“SCCMSITE_F3841056-33E5-46D8-B921-6E26ABFACC4B_OS_C765723E-
B286-4A65-CB6C-6218EBAFC386_1_Type” xmlns:xsi=“http://www.w3.org/2001/XMLSchema-instance”>
    <xs:complexContent>
      <xs:extension base=“sfw:InstalledWindowsOperatingSystemType”>
        <xs:sequence />
      </xs:extension>
    </xs:complexContent>
  </xs:complexType>
  <xs:element name=“SCCMSITE_F3841056-33E5-46D8-B921-6E26ABFACC4B_OS_C765723E-B286-
4A65-CB6C-6218EBAFC386_1_Instance” type=“tns:SCCMSITE_F3841056-33E5-46D8-B921-
6E26ABFACC4B_OS_C765723E-B286-4A65-CB6C-6218EBAFC386_1_Type”
xmlns:xsi=“http://www.w3.org/2001/XMLSchema-instance” />
  <xs:element name=“SCCMSITE_F3841056-33E5-46D8-B921-6E26ABFACC4B_OS_C765723E-B286-
4A65-CB6C-6218EBAFC386_1_Ref” type=“sdm:ref” sdm:targetType=“tns:SCCMSITE_F3841056-33E5-
46D8-B921-6E26ABFACC4B_OS_C765723E-B286-4A65-CB6C-6218EBAFC386_1_Type”
substitutionGroup=“sfw:InstalledOperatingSystemRef” xmlns:xsi=“http://www.w3.org/2001/XMLSchema-
instance”>
    <xs:annotation xmlns:msxsl=“urn:schemas-microsoft-com:xslt”>
      <xs:appinfo>
        <sch:schema>
          <sch:ns prefix=“ns_OS_C765723E-B286-4A65-CB6C-6218EBAFC386_this”
uri=“http://schemas.microsoft.com/systemsmanagementserver/SCCMSITE_F3841056-33E5-46D8-B921-
6E26ABFACC4B/OS_C765723E-B286-4A65-CB6C-6218EBAFC386/1” />
          <sch:ns prefix=“mssmlfn” uri=“http://schemas.microsoft.com/sml/functions/2007/03” />
          <sch:ns prefix=“cis”
uri=“http://schemas.microsoft.com/systemsmanagementserver/ConfigurationItems_1.0.0.0” />
          <sch:ns prefix=“sfw”
uri=“http://schemas.microsoft.com/systemsmanagementserver/Software_1.0.0.0” />
          <sch:ns prefix=“fs”
uri=“http://schemas.microsoft.com/systemsmanagementserver/FileSystem_1.0.0.0” />
          <sch:ns prefix=“dci”
uri=“http://schemas.microsoft.com/SystemsCenterConfigurationManager/DesiredConfiguration/InstanceData/2006/04” />
        </sch:schema>
      </xs:appinfo>
    </xs:annotation>
  </xs:element>
  <xs:complexType name=“SCCMSITE_F3841056-33E5-46D8-B921-6E26ABFACC4B_OS_C765723E-
B286-4A65-CB6C-6218EBAFC386_1_Policy” xmlns:xsi=“http://www.w3.org/2001/XMLSchema-instance”>
    <xs:annotation xmlns:msxsl=“urn:schemas-microsoft-com:xslt”>
      <xs:appinfo>
        <sch:schema>
          <sch:ns prefix=“ns_OS_C765723E-B286-4A65-CB6C-6218EBAFC386_this”
uri=“http://schemas.microsoft.com/systemsmanagementserver/SCCMSITE_F3841056-33E5-46D8-B921-
6E26ABFACC4B/OS_C765723E-B286-4A65-CB6C-6218EBAFC386/1” />
          <sch:ns prefix=“mssmlfn” uri=“http://schemas.microsoft.com/sml/functions/2007/03” />
          <sch:ns prefix=“cis”
uri=“http://schemas.microsoft.com/systemsmanagementserver/ConfigurationItems_1.0.0.0” />
          <sch:ns prefix=“sfw”
uri=“http://schemas.microsoft.com/systemsmanagementserver/Software_1.0.0.0” />
          <sch:ns prefix=“fs”
uri=“http://schemas.microsoft.com/systemsmanagementserver/FileSystem_1.0.0.0” />
          <sch:ns prefix=“dci”
uri=“http://schemas.microsoft.com/SystemsCenterConfigurationManager/DesiredConfiguration/InstanceData/2006/04” />
          <sch:pattern>
            <sch:rule mssml:contextQuery=“cis:Applicability”>
              <sch:assert test=“.=‘true’” mssml:category=“dcm:Applicability” mssml:severity=“warning”
dci:DigestElement=“OS_C765723E-B286-4A65-CB6C-6218EBAFC386” dci:ModelTestElement=“.”>
***
***
***
id=OS_C765723E-B286-4A65-CB6C-6218EBAFC386_Applicability
dci:DigestElement=OS_C765723E-B286-4A65-CB6C-6218EBAFC386
***
***
***
</sch:assert>
            </sch:rule>
          </sch:pattern>
          <sch:pattern>
            <sch:rule mssml:contextQuery=“cis:SetCompleteness”>
              <sch:assert test=“.=‘true’” mssml:category=“dcm:SetCompletenessExistential”
mssml:severity=“warning” dci:DigestElement=“OS_C765723E-B286-4A65-CB6C-6218EBAFC386”
dci:ModelTestElement=“.”>
***
***
***
id=OS_C765723E-B286-4A65-CB6C-6218EBAFC386_SetCompletenessExistential
dci:DigestElement=OS_C765723E-B286-4A65-CB6C-6218EBAFC386
***
***
***
</sch:assert>
            </sch:rule>
          </sch:pattern>
          <sch:pattern>
            <sch:rule mssml:contextQuery=“.”>
              <sch:assert test=“(count(*/@uri)&gt;0)” mssml:category=“dcm:Existential”
mssml:severity=“warning” dci:DigestElement=“OS_C765723E-B286-4A65-CB6C-6218EBAFC386”
dci:ModelTestElement=“tns:OS_C765723E-B286-4A65-CB6C-6218EBAFC386_Ref”>
***
***
***
id=OS_C765723E-B286-4A65-CB6C-6218EBAFC386_Existential
dci:DigestElement=OS_C765723E-B286-4A65-CB6C-6218EBAFC386
***
***
***
</sch:assert>
            </sch:rule>
          </sch:pattern>
          <sch:pattern>
            <sch:rule
mssml:contextQuery=“cis:ConfigurationExtensions/cis:OtherExtensionElement/dci:VersionInfo/dci:VersionCompatible”>
              <sch:assert test=“.=‘true’” mssml:category=“dcm:Versioning” mssml:severity=“warning”
dci:DigestElement=“OS_C765723E-B286-4A65-CB6C-6218EBAFC386” dci:ModelTestElement=“.”>
***
***
***
id=OS_C765723E-B286-4A65-CB6C-6218EBAFC386_VersionCompatibility
dci:DigestElement=OS_C765723E-B286-4A65-CB6C-6218EBAFC386
***
***
***
</sch:assert>
            </sch:rule>
            </sch:pattern>
        </sch:schema>
      </xs:appinfo>
    </xs:annotation>
    <xs:complexContent>
      <xs:restriction base=“cis:InstalledWindowsOperatingSystemConfigurationType”>
        <xs:sequence>
          <xs:element ref=“cis:Applicability” />
          <xs:element ref=“cis:SetCompleteness” />
          <xs:element ref=“cis:ConfigurationExtensions” minOccurs=“0” maxOccurs=“1” />
          <xs:choice minOccurs=“0” maxOccurs=“1”>
            <xs:element ref=“tns:SCCMSITE_F3841056-33E5-46D8-B921-6E26ABFACC4B_OS_C765723E-
B286-4A65-CB6C-6218EBAFC386_1_Ref” />
          </xs:choice>
        </xs:sequence>
      </xs:restriction>
    </xs:complexContent>
  </xs:complexType>
  <xs:element name=“SCCMSITE_F3841056-33E5-46D8-B921-6E26ABFACC4B_OS_C765723E-B286-
4A65-CB6C-6218EBAFC386_1” type=“tns:SCCMSITE_F3841056-33E5-46D8-B921-
6E26ABFACC4B_OS_C765723E-B286-4A65-CB6C-6218EBAFC386_1_Policy”
substitutionGroup=“cis:InstalledWindowsOperatingSystemConfiguration”
xmlns:xsi=“http://www.w3.org/2001/XMLSchema-instance” />
</xs:schema>
```

One aspect of the document is to provide a way for administrators to specify one or more units of expressed desire with respect to conformance evaluation decisions made during processing actions driven by the document. In the example above, such subunits of expressed desire actions are identified by italics and shading; note that this is only for purposes of visibility, and that italics and/or shading are not interpreted differently.

Thus, there is provided a constitutional document structure, in the form of XML Schema, containing embedded documents in the form of XML standard processing languages. The document structure is capable of being executed by XML standard processors to perform evaluation and transformation tasks, e.g., by processors such as an XML Schema validator, XML Schematron validator and XSLT stylesheet.

In this manner, standard XML processors, used in a configuration management processing agent, can be completely predictably directed in the order of their task activity, using only the aggregate structure present, within the context of a collection with documents having the same structure. The intent-structure of each document constitutes a total task activity that is predictable and orderly in execution. However, a management authority may direct the agent to change the names of the documents in a given set and thereby reprogram the total task activity.

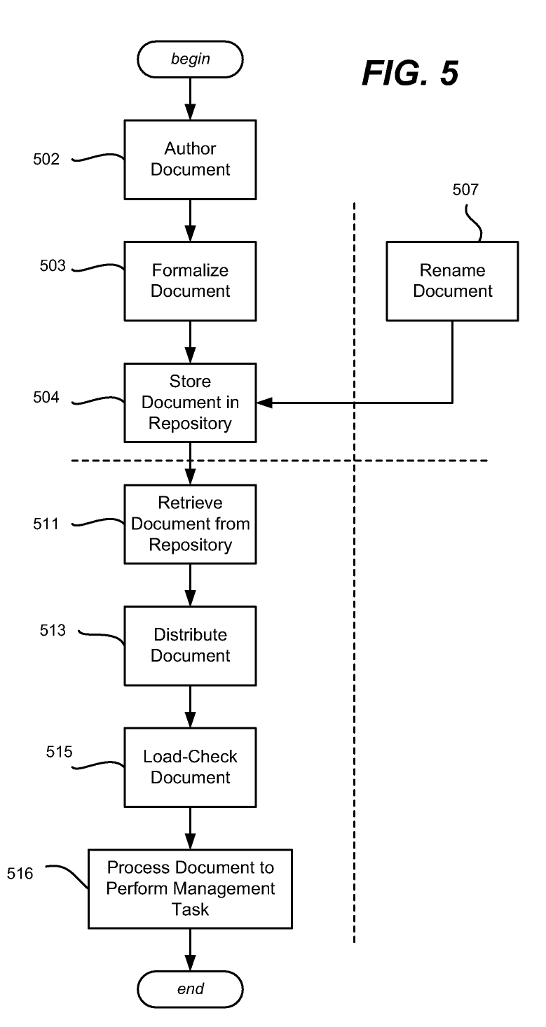

FIG. 5 summarizes various aspects with respect to a document, beginning at step 502 which represents the authoring of the document. Step 503 represents formalizing the document in some way, e.g., converting an administrator's intent as entered into a user interface into the document structure whose conformance can be evaluated with respect to performing a management task. Step 504 represents storing the document in a repository, where it can be accessed and optionally renamed (step 507). Note that in FIG. 5, the dashed lines generally indicate independent operations in time and/or space, e.g., renaming may take place at any time.

Sometime later, (again as indicated by the dashed lines), the document is retrieved (step 511) from the repository, whether alone or in a set with other such documents. The document may be distributed via step 513 to one or more agents, where it is load-checked (step 515), and if correct, processed to perform the management task, such as to ensure conformance of the agent's machine to a policy.

To summarize one implementation, there is described a data language family/suite, sharing the same serialization, having a schema language, transformation language and rule (predicate, expression) language. A schema language is provided, in which valid instances are bound or considered to define or target a ‘namespace’, being a universal identifier such as a URI or GUID, and in which each defined schema is a unique definition of content. Such a suite is characterized by common serialization and a trio of kinds of languages, wherein each of which kind of language has the ability to process the other kinds of language.

Further exemplified in the suite of data languages, is that each of the three languages is capable of possessing an import statement, allowing an appearance of the language to stand in relation to another document; an import statement in each language is defined by that language's standard, and whose including-action-behavior is defined thereby. Each kind of language is defined and capable of acting on instances of its own language. Each language and its including behavior has a documented means of resolving mutual definitions, establishing relative ordering, determining priority and precedence between statements, and means to detect incomplete content; this is done at load-time, without there being a requirement to execute the language.

Further, the schema language has the ability to express data structure requirements over transformation language or rule language (that is, the transform and/or rule language are each able to be described by the schema language). The transformation language is capable of taking as input and/or generating as output valid instances of schema language or rule language. The rule language is capable of expressing predicating expressions over instances of schema language or transformation language.

The data language family/suite further accommodates data-carriage sections, that is, application information (AppInfo) sections, containing unprocessed content (relative to schema language) that may be directly associated with instances of schema language. An alternative is to use an “XML open-content model,” where unprocessed language is free-form. without direct syntactic association.

The data language family/suite, with the schema language and application information sections may be attached at a namespace (universal) level, global type level or local type level. Sections at the namespace level need not be associated with any particular type, but may be associated with the namespace as a whole.

One suitable transformation language is XSLT, comprising a functional language that does not have side-effects, nor ‘assignment statements’. (Transformations are described further in the aforementioned related patent application.)

One suitable rule language, e.g., Schematron, comprises a predicating expression language that may contain instances of query expressions and instances of pattern expressions. The rule language may define expressions that are ‘antecedent’ (e.g., if-like statements), but need not contain ‘consequents’ (then-like statements). For example, an “if” statement may simply trigger some alert, rather than take an active “then” action, e.g., the alert may or may not be acted upon by another entity.

Further described in one exemplified implementation is a distributed network management solution, having individual units of policy in the form of documents composed from the suite. A unit of policy, comprising a constituted document, is, in total (overall format), a valid instance of schema language. In general, the only packets of communication are instances of the constituted document or documents, in total schema language (and not with documents of other file formats, languages and/or content). The management solution may rely solely on such documents.

The appearance of rule language, within application info sections, is resolved (that is, understood in terms of priority and precedence) in accordance with the scope of the schema type to which it is attached. The constituted document may comprise a unit of policy containing schema language, (e.g., without any appearance of transformation language or rule language). The constituted document may comprise a unit of policy containing an instance of transformation language at ‘top-level’ (namespace, universal), unattached to a type; (although it may be attached to a type at global or local level).

The constituted document may comprise a unit of policy containing one application info section which contains transformation language, and not having any occurrence of rule language. The constituted document may comprise a unit of policy containing exactly one application info section which contains rule language, at namespace (level) level. Such an occurrence of rule language, being understood to apply to the entire namespace, and not any particular type.

The constituted document may comprise a unit of policy containing rule language attached at the global level (with a global type), which is understood in relation to the inheritance position of the type. For example, schema A with global type AT with attached rules ATR, Schema B with global type BT, with attached rules BTR, and types AT and BT are understood in a schema ‘extension’ relation, with rules ATR and BTR, mutually ‘resolved’ in the same precedence relation as AT, BT.

A processing set of documents, for a processing agency, may be one unit of policy. The processing set of documents for a processing agency may be two or more documents, having cross-document relations through the use of an import statement. A processing agency for constituted documents may have in its possession a set of initial or base units of policy, containing common or shared content, which is pre-distributed to the agency nodes.

The unit of policy may be a constituted document, or set of documents, which while possibly incomplete by themselves, may have an expectation of resolution at the agency via one or more base documents. The set of policy may have documents that are related through use of import at namespace level for schema documents. The set of policy may be arranged as a tree structure, with a designated head schema document, such that documents found in the set are related through import relations.

A management solution is described, in which the master inventory of documents constitute the set, indicate what the set contains, with such information being the namespace level schema import relations. The set of policy documents, having schema import relations at schema namespace level, have occurrence of transformation or rule language at any level; such transformation or rule language also make use of the language's import facility.

In one embodiment, the transformation or rule language import identifies other documents through the use of the schema namespace identifier. In an alternative embodiment, the target of the import is expressed through a different set of identifiers (such as guids, filenames, database storage paths), which may be different from the space of identifiers used for the namespace.

A policy management solution is described, having a means to detect the absence (state of being missing) of documents or instances of language (detect missing definitions or undefined content references), in which the means is the behavior standard of the language. The solution includes means to resolve mutual redefinitions (conflicts) through a priority or precedence mechanism, which is the behavior standard of the language. Such resolution is defined as the deterministic determining of processing order of language statements relative to one another.

A policy management solution includes a resolution process, comprising the behavior of their languages, wherein precedence of processing order of language statements is determined. Instances of rule language standing in relation are resolved in their processing or applying order, which is dictated by the inheritance relations of the schema types to which the rule language is attached. Instances of the transformation language, have a set of templates, matching functions or event handlers that may be applied in various circumstances, such activation of the templates being governed by import or precedence derived from the mutual relative order of their import (rather than by type association).

A policy management solution performs a ‘load’ operation on a set of documents prior to initiating execution of documents. The load operation is capable (by the combined language standards) of resolving any ambiguities and/or conflicts in advance of processing. The policy processing agency thus has a load phase prior to a run phase, wherein at the conclusion of the load-phase, the set of policy documents is resolved and decided, either having a complete closure with complete information, or being able to detect/decide on incomplete closure. The run phase takes place on complete closure, not on incomplete closure.

### Exemplary Operating Environment

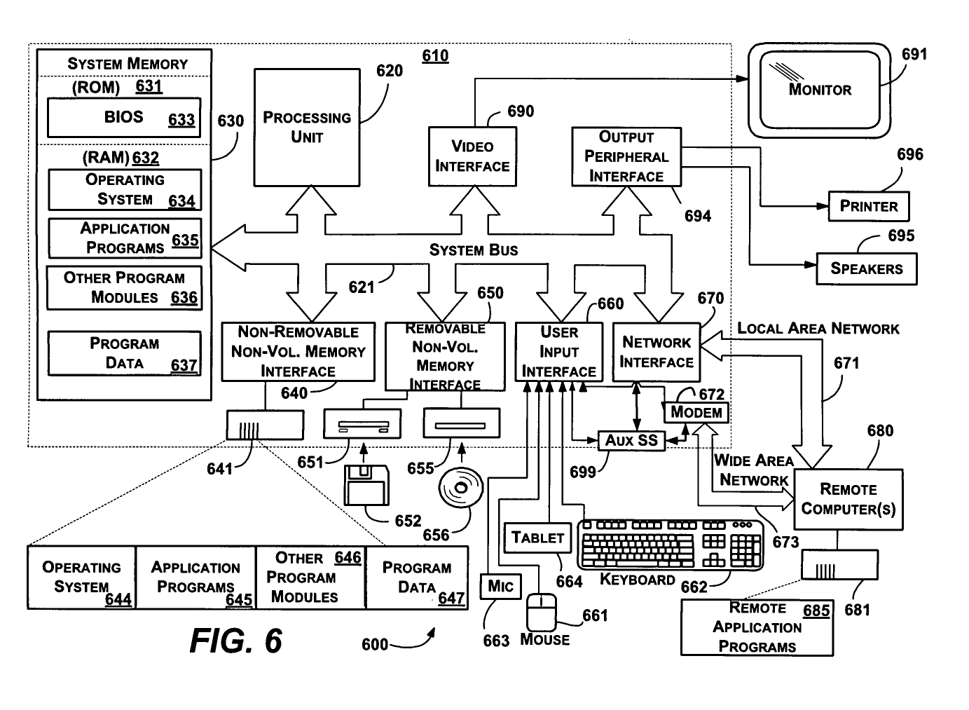

FIG. 6 illustrates an example of a suitable computing and networking environment 600 on which the examples and/or implementations of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, embedded systems, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 655 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 645 and program data 647. Note that these components can either be the same as or different from operating system 634, application programs 635, other program modules 635, and program data 637. Operating system 644, application programs 645, other program modules 645, and program data 647 are given different numbers herein to illustrate that, at a minimum, they are different copies. A user may enter commands and information into the computer 610 through input devices such as a tablet, or electronic digitizer, 654, a microphone 653, a keyboard 652 and pointing device 651, commonly referred to as mouse, trackball or touch pad. Other input devices not shown in FIG. 6 may include a joystick, game pad, satellite dish, scanner, or the like. These and other input devices are often connected to the processing unit 620 through a user input interface 650 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 695, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 650 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 650 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. One or more computer-readable media having stored thereon a data structure, comprising:
at least one schematic language statement;
at least one data transformation statement;
at least one rule statement; and
the data structure structured so as to be validated, without reference to an external source, as being correct with respect to executing statements of the data structure to perform a management task.

2. The computer-readable media of claim 1 wherein the data structure comprises a document, and wherein the schematic language statement is contained in a top-level of the document that is processed before any lower level of the document.

3. The computer-readable media of claim 2 wherein each data transformation statement is contained in a second level below the top-level.

4. The computer-readable media of claim 3 wherein information in the second-level applies to the document as a document-wide scope pattern.

5. The computer-readable media of claim 3 wherein one or more rule statements are contained in a second level below the top-level.

6. The computer-readable media of claim 3 wherein at least one other rule statement is contained in an embedded level below the second level.

7. The computer-readable media of claim 6 wherein information in the embedded-level applies to the embedded level as a type-relative scope pattern.

8. The computer-readable media of claim 1 wherein the data structure comprises a document, and wherein the document contains a reference to a referenced document.

9. The computer-readable media of claim 1 wherein the data structure comprises a document, and wherein the document imports another document.

10. The computer-readable media of claim 1 wherein the data structure comprises a document, and wherein the document is associated with an application as being a base document, or wherein the document is associated with an application as being a member document.

11. The computer-readable media of claim 1 wherein the data structure comprises a document, and wherein the document is associated with an application as being a head document that is loaded before a body document.

12. The computer-readable media of claim 1 wherein the data structure comprises a document, and wherein the document comprises a child document that has a relationship to a parent document.

13. The computer-readable media of claim 1 wherein the data structure comprises a document, and wherein the document comprises a rollup document that specifies the processing of at least two other documents.

14. In a computing environment, a method comprising:
distributing a structured document to an agent; and
processing information corresponding to the structured document to perform a management task, including executing the document based upon a schematic statement in the document, transforming data based upon a data transformation statement in the document, and executing an if-then statement based upon a rule statement in the document.

15. The method of claim 14 further comprising, inserting content from an imported document that is identified in the structured document into the information corresponding to the structured document.

16. The method of claim 14 further comprising, determining whether the structured document is a head document, and if so, loading the structured document before another document specified as a body document relative to the structured document.

17. The method of claim 14 further comprising, processing application information content embedded in the document.

18. In a computing environment, a system comprising:
an authoring mechanism by which an author specifies machine configuration policy;
a transformation mechanism coupled to the authoring mechanism that formalizes the configuration policy into a constitutional document for storing in a repository;
a targeting and assignment mechanism that identifies a the constitutional document in the repository for distribution to targeted network machines, the targeting and assignment mechanism being independent of the authoring mechanism and the transformation mechanism; and
a distribution mechanism coupled to the targeting mechanism to distribute the constitutional document to the targeted network machines, each targeted network machine including an agent that executes the constitutional document to perform a management task on that targeted network machine.

19. The system of claim 18 wherein the agent includes a standard XML-type processor for executing the constitutional document.

20. The system of claim 1 wherein the agent is associated with an application that specifies whether the document is a base document or a member document, or specifies whether the document is a head document relative to a body document or a body document relative to a head document, or specifies both whether the document is a base document or a member document, and whether the document is a head document relative to a body document or a body document relative to a head document.
